(19) United States
(12) Patent Application Publication
(10) Pub. No.: US 2026/0167230 A1
(43) Pub. Date: Jun. 18, 2026

(54) Apparatus for Controlling Autonomous Driving and Method for Controlling Junction Thereof

(71) Applicants: Hyundai Motor Company, Seoul (KR); Kia Corporation, Seoul (KR)

(72) Inventors: Jeong Woo Kim, Hwaseong-Si (KR); Sung Yoon Yeo, Hwaseong-Si (KR); Seung Joon Lee, Hwaseong-Si (KR); Su Jung Yoo, Hwaseong-Si (KR); Beom Jun Kim, Hwaseong-Si (KR)

(21) Appl. No.: 19/228,992

(22) Filed: Jun. 5, 2025

(30) Foreign Application Priority Data
Dec. 18, 2024 (KR) 10-2024-0189556

(51) Int. Cl. B60W 60/00; B60W 30/18; G08G 1/16

(52) U.S. Cl. CPC B60W 60/0027; B60W 30/18163; G08G 1/167; B60W 2520/10; B60W 2552/10; B60W 2554/4041; B60W 2554/4042; B60W 2555/60; B60W 2720/10

(57) ABSTRACT

An apparatus for controlling autonomous driving of a host vehicle may comprise a processor and a memory storing at least one instruction that, when executed by the processor communicating with the memory, is configured to cause the apparatus to select at least one target candidate vehicle expected to enter a road merging section on which the host vehicle is driving, determine a target yielding level associated with the at least one target candidate vehicle, wherein the target yielding level corresponds to a value indicating a likelihood for the host vehicle to yield to the at least one target candidate vehicle, select, based on the determined target yielding level, a final target vehicle, output a signal, and control autonomous driving of the host vehicle.

### CROSS-REFERENCE TO RELATED APPLICATION

This application claims the benefit of priority to Korean Patent Application No. 10-2024-0189556, filed with the Korean Intellectual Property Office on Dec. 18, 2024, the entire contents of which are incorporated herein by reference.

### TECHNICAL FIELD

The present disclosure relates to an autonomous driving control apparatus and an autonomous driving control method in a road merging section, and more specifically, to a technique for controlling an autonomous vehicle to yield to a vehicle entering a merging road in the road merging section.

### BACKGROUND

The matters described in this Background section are only for enhancement of understanding of the background of the disclosure, and should not be taken as acknowledgment that they correspond to prior art already known to those skilled in the art.

An autonomous vehicle is a vehicle that recognizes its surroundings through external information detection and processing functions while driving, determines its driving path by itself, and drives independently using a power thereof. An autonomous vehicle is a smart vehicle that is equipped with an autonomous driving technique that allows the vehicle to reach a destination thereof by itself without a driver having to directly operate a steering wheel, an accelerator pedal, or a brake.

Roads may be classified into various types according to their shapes, sizes, and functions, but they can basically be configured to branch out from one road into multiple roads or to merge multiple roads into one road.

In a case where multiple roads are built to merge into one road, vehicles entering a merging road may yield to each other and drive on the single road.

However, autonomous vehicles may not have a separate strategy for vehicles entering the merging road in a merging section of a road or may not drive in a similar manner to a preceding vehicle.

Accordingly, strategies and response measures are considered to enable autonomous vehicles to drive more efficiently in a case of driving in the merging section.

### SUMMARY

Furthermore, various effects which may be directly or indirectly identified through the present specification may be provided.

According to the present disclosure, an apparatus for controlling autonomous driving of a host vehicle, the apparatus may comprise a processor, and a memory storing at least one instruction that, when executed by the processor communicating with the memory, is configured to cause the apparatus to select at least one target candidate vehicle that is expected to enter a road merging section on which the host vehicle is driving, determine a target yielding level associated with the at least one target candidate vehicle, wherein the target yielding level corresponds to a value indicating a likelihood for the host vehicle to yield to the at least one target candidate vehicle, select, based on the determined target yielding level, a final target vehicle among the at least one target candidate vehicle, output, based on the selected final target vehicle, a signal, and control, based on the signal, autonomous driving of the host vehicle to yield to the final target vehicle.

The apparatus, wherein the at least one instruction, when executed by the processor communicating with the memory, is configured to cause the apparatus to select, based on at least one of a speed of the host vehicle, information about an object within a threshold distance of the host vehicle, or merging section information about the road merging section, the final target vehicle among the at least one target candidate vehicle. The apparatus, wherein the information about the object may comprise a position or a speed of the object.

The apparatus, wherein the merging section information may comprise at least one of a start point of the road merging section, an end point of the road merging section, a type of the road merging section, or a driving direction of the road merging section.

The apparatus, wherein the at least one instruction, when executed by the processor communicating with the memory, is configured to cause the apparatus to select a vehicle as a target candidate vehicle based on the vehicle driving in a lane next to a lane on which the host vehicle is driving, and the vehicle having a risk of collision with the host vehicle at an end point of the road merging section, wherein the risk of collision exceeds a predetermined reference value.

The apparatus, wherein the at least one instruction, when executed by the processor communicating with the memory, is configured to cause the apparatus to determine the target yielding level associated with the at least one target candidate vehicle based on at least one of a predetermined maximum yielding level, a predetermined minimum yielding level, a minimum time threshold for arrival of the at least one target candidate vehicle at a merging end point, a maximum time threshold for arrival of the at least one target candidate vehicle at the merging end point, or a current time remaining until the at least one target candidate vehicle arrives at the merging end point.

The apparatus, wherein the at least one instruction, when executed by the processor communicating with the memory, is configured to cause the apparatus to determine a final yielding level based on at least one of the target yielding level, a predetermined maximum adjustment factor applied to the target yielding level, a predetermined minimum adjustment factor applied to the target yielding level, a predetermined maximum speed of the host vehicle, a predetermined minimum speed of the host vehicle, or a current speed of the host vehicle.

The apparatus, wherein the at least one instruction, when executed by the processor communicating with the memory, is configured to cause the apparatus to determine a final yielding level of each of the at least one target candidate vehicle, and generate a speed profile for tracking a target vehicle for each of the at least one target candidate vehicle, based on a control target distance, wherein the control target distance defines an inter-vehicle distance to be maintained between the host vehicle and the target vehicle, and wherein the control target distance is determined based on the final yielding level, and a deceleration tuning parameter, wherein the deceleration tuning parameter is used to adjust a deceleration rate of the host vehicle during the tracking, and wherein the deceleration tuning parameter is determined based on the final yielding level.

The apparatus, wherein the at least one instruction, when executed by the processor communicating with the memory, is configured to cause the apparatus to select a target candidate vehicle having a speed profile with a smallest acceleration average value for a predetermined time period as a final target candidate vehicle by comparing acceleration average values for the predetermined time period among the speed profiles generated for each of the at least one target candidate vehicle for tracking the target candidate vehicle.

The apparatus, wherein the speed profile with the smallest acceleration average value is selected among a speed profile for tracking an event target speed, a speed profile for tracking a maximum operating speed, and a speed profile for minimal risk maneuver (MRM).

The apparatus, wherein the speed profile for tracking the event target speed may comprise a speed profile generated for tracking in event situations, wherein the event situations may comprise entering a curved road section and entering the road merging section, and the speed profile for tracking the maximum operating speed may comprise a speed profile based on a maximum operating speed, wherein the maximum operating speed may comprise at least one of a road speed limit or a design maximum speed of an autonomous driving system.

According to the present disclosure, a method performed by an apparatus for controlling autonomous driving of a host vehicle, the method may comprise selecting at least one target candidate vehicle that is expected to enter a road merging section on which the host vehicle is driving, determining a target yielding level associated with the at least one target candidate vehicle, wherein the target yielding level corresponds to a value indicating a likelihood for the host vehicle to yield to the at least one target candidate vehicle, selecting, based on the determined target yielding level, a final target vehicle among the at least one target candidate vehicle, outputting, based on the selected final target vehicle, a signal, and controlling, based on the signal, autonomous driving of the host vehicle to yield to the final target vehicle.

The method, wherein the selecting of the final target vehicle may comprise selecting, based on at least one of a speed of the host vehicle, information about an object within a threshold distance of the host vehicle, or merging section information about the road merging section, the final target vehicle among the at least one target candidate vehicle.

The method, wherein the information about the object may comprise a position or a speed of the object, and the merging section information may comprise at least one of a start point of the road merging section, an end point of the road merging section, a type of the road merging section, or a driving direction of the road merging section.

The method, wherein the selecting of the final target vehicle may comprise selecting a vehicle as a target candidate vehicle based on the vehicle driving in a lane next to a lane on which the host vehicle is driving, and the vehicle having a risk of collision with the host vehicle at an end point of the road merging section, wherein the risk of collision exceeds a predetermined reference value.

The method, wherein the determining of the target yielding level associated with the at least one target candidate vehicle may comprise determining the target yielding level based on at least one of a predetermined maximum yielding level, a predetermined minimum yielding level, a minimum time threshold for arrival of the at least one target candidate vehicle at a merging end point, a maximum time threshold for arrival of the at least one target candidate vehicle at the merging end point, or a current time remaining until the at least one target candidate vehicle arrives at the merging end point.

The method, wherein the determining of the target yielding level associated with the at least one target candidate vehicle may further comprise determining a final yielding level based on at least one of the target yielding level, a predetermined maximum adjustment factor applied to the target yielding level, a predetermined minimum adjustment factor applied to the target yielding level, a predetermined maximum speed of the host vehicle, a predetermined minimum speed of the host vehicle, or a current speed of the host vehicle.

The method, wherein the selecting of the final target vehicle may comprise selecting a target candidate vehicle having a speed profile with a smallest acceleration average value for a predetermined time period as a final target candidate vehicle by comparing acceleration average values for the predetermined time period among the speed profiles generated for each of the at least one target candidate vehicle for tracking the target candidate vehicle.

According to the present disclosure, an apparatus for controlling autonomous driving of a vehicle, the apparatus may comprise a processor, and a memory storing at least one instruction that, when executed by the processor communicating with the memory, is configured to cause the apparatus to select at least one target candidate vehicle predicted to enter a merging road on which the vehicle is driving, based on at least one of object information associated with the vehicle or merging section information associated with the merging road, determine a yielding level associated with each of the at least one target candidate vehicle based on at least one of a collision risk or a time remaining until the at least one target candidate vehicle arrives at an end point of the merging road, wherein the yielding level corresponds to a value indicating a likelihood for the vehicle to yield to the at least one target candidate vehicle, select, based on the determined yielding level, a target vehicle from the at least one target candidate vehicle, output a signal indicating the selected target vehicle, and control, based on the signal, autonomous driving of the vehicle to yield to the selected target vehicle.

The apparatus, wherein the object information may comprise at least one of a position or a speed of an object within a threshold range of the vehicle, the merging section information may comprise at least one of a start point, an end point, a type, or a driving direction of the merging road, the selected target vehicle has a speed profile with a smallest acceleration average value for a predetermined time period, and the determining the yielding level is further based on at least one of a predetermined maximum yielding level or a predetermined minimum yielding level.

### BRIEF DESCRIPTION OF THE DRAWINGS

FIG. 1 shows an example configuration of a vehicle system including an autonomous driving control apparatus.

FIG. 2 shows an example of a road merging section.

FIG. 3 shows an example speed profile of an autonomous driving control apparatus.

FIG. 4 shows an example control method in a road merging section for an autonomous driving control apparatus.

FIG. 5 shows an example computing system.

### DETAILED DESCRIPTION

Hereinafter, some examples of the present disclosure will be described in detail with reference to exemplary drawings. It should be noted that in adding reference numerals to constituent elements of each drawing, the same constituent elements include the same reference numerals as possible even though they are indicated on different drawings. In describing an example of the present disclosure, when it is determined that a detailed description of the well-known configuration or function associated with the example of the present disclosure may obscure the gist of the present disclosure, it will be omitted.

In describing constituent elements according to an example of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which an example of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of autonomous driving control in a road merging section) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of autonomous driving control in a road merging section) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of autonomous driving control in a road merging section) described herein.

Minimum risk maneuver (MRM) operation(s) may also be controlled, for example, based on one or more features (e.g., features of autonomous driving control in a road merging section) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of autonomous driving control in a road merging section) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of autonomous driving control in a road merging section) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

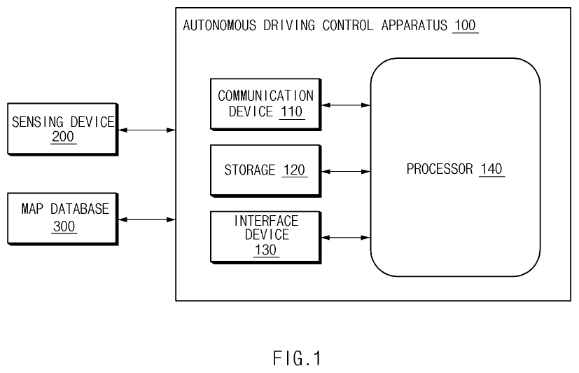

Hereinafter, various examples of the present disclosure will be described in detail with reference to FIG. 1 to FIG. 5.

FIG. 1 shows an example configuration of a vehicle system including an autonomous driving control apparatus.

Referring to FIG. 1, the vehicle system according to an example of the present disclosure may be configured to include an autonomous driving apparatus 100, a sensing device 200, and a map database 300.

According to an example of the present disclosure, the autonomous driving control apparatus 100 may be implemented within or separately from a vehicle. In this case, the autonomous driving control apparatus 100 may be integrally formed with internal control units of the vehicle, or may be implemented as a separate hardware device to be connected to control units of the vehicle by a connection means. For example, the autonomous driving control apparatus 100 may be implemented integrally with the vehicle, may be mounted on a dashboard, under a seat, or within a control panel, or may be implemented in a form that is installed or attached to the vehicle as a configuration separate from the vehicle, or a part thereof may be implemented integrally with the vehicle, and another part may be implemented in a form that is installed or attached to the vehicle as a configuration separate from the vehicle. In some cases, the apparatus may be embedded in a telematics circuitry, an electronic control circuit, or a central computing platform, etc.

The autonomous driving control apparatus 100 may be configured to perform autonomous driving control naturally according to a traffic flow by performing a yielding control strategy for surrounding objects in a road merging section.

The autonomous driving control apparatus 100 may be configured to select at least one target candidate vehicle that is expected or predicted to enter a merging road on which a host vehicle is driving in the road merging section, such as a passenger car, a truck, a motorcycle, or a bus, etc., select a final target vehicle among the at least one target candidate vehicle by determining a target level of the at least one target candidate vehicle, and control the host vehicle to yield to the final target vehicle in response to a case where the final target vehicle attempts to enter a merging lane on which the host vehicle is driving at an end point of the merging section of the road. For example, this yielding may occur based on real-time evaluations of vehicle speed, lane geometry, or estimated time to collision, etc.

In the instant case, the target candidate vehicle may indicate a vehicle that drives in the merging section, which is a lane next to the lane on which the host vehicle is driving, and enters the merging lane on which the host vehicle is driving at the end point of the merging section, but that has a risk level of colliding with the host vehicle exceeding a predetermined reference and is likely to be yielded by the host vehicle, and is hereinafter referred to as a yielding target candidate vehicle. The risk level may be computed based on predicted time-to-collision, lane overlap probability, or relative velocity thresholds, etc. Furthermore, the final target vehicle may indicate one vehicle among the yielding target candidate vehicles to which the host vehicle has decided to yield, and is referred to as a final yielding target vehicle hereinafter, and the host vehicle may be controlled to yield in response to the final yielding target vehicle entering the merging lane. This yielding action may include slowing down, adjusting lateral position, or temporarily suspending acceleration, etc. Furthermore, a target level of the vehicle may be a level for yielding, and the target level may increase as a possibility of being yielded increases, and is hereinafter referred to as a yielding level of the vehicle. The yielding level may be dynamically adjusted based on environmental context (e.g., road curvature, merge angle, or visibility range, etc.). Examples of yielding target candidate vehicles may include vehicles performing abrupt acceleration, maintaining close proximity to the merging point, or signaling an intent to merge, changing lanes aggressively, or matching the host vehicle's speed to force a merge, etc.

The autonomous driving control apparatus 100 may include a communication device 110, a storage 120, an interface device 130, and a processor 140. According to an example of the present disclosure, the autonomous driving control apparatus 100 may be implemented as a single unit by coupling components with each other, and some components may be omitted. For example, in lightweight system configurations, the interface device 130 may be omitted, or the communication device 110 may be integrated with the processor 140.

The communication device 110 may be a hardware device implemented with various electronic circuits to transmit and receive signals through a wireless or wired connection, and may be configured to transmit and receive information based on in-vehicle devices and in-vehicle network communication techniques. As an example of the present disclosure, the in-vehicle network communication techniques may include Controller Area Network (CAN) communication, Local Interconnect Network (LIN) communication, flex-ray communication, Ethernet, or MOST (Media Oriented Systems Transport), etc.

The communication device 110 may be a hardware device implemented with various electronic circuits to transmit and receive signals through wireless or wired connections, and may be configured to perform communication with in-vehicle devices. For example, the communication device 110 may be configured to receive data from the sensing device 200 and the map database 300. In some cases, the communication device may interface with external devices such as cloud servers, remote diagnostics tools, or over-the-air (OTA) update platforms, etc.

As an example of the present disclosure, the in-vehicle network communication techniques may include Controller Area Network (CAN) communication, Local Interconnect Network (LIN) communication, flex-ray communication, FlexRay communication, or other automotive-specific communication protocols, etc.

The communication device 110 may be configured to perform V2X communication. The V2X communication may include communication between vehicle and all entities such as V2V (vehicle-to-vehicle) communication which refers to communication between vehicles, V2I (vehicle to infrastructure) communication which refers to communication between a vehicle and an eNB or road side unit (RSU), V2P (vehicle-to-pedestrian) communication, which refers to communication between user equipment (UE) held by vehicles and individuals (e.g., pedestrians, cyclists, vehicle drivers, or occupants, etc.), and V2N (vehicle-to-network) communication. For example, the communication device 110 may be configured to receive information such as a speed and a position of a vehicle driving in a merging section through communication with surrounding vehicles driving in the merging section. This information may be used to assess merging risk, predict intentions, or determine yielding priorities, etc.

Furthermore, the communication device 110 may include a mobile communication module, a wireless Internet module, a short-range communication module, etc, for communication with outside of the vehicle (e.g., for communication with external systems such as cloud platforms, traffic control centers, or navigation services, etc.).

The mobile communication module may be configured to perform communication using technical standards or communication methods for mobile communication (e.g., Global System for Mobile communication (GSM), Code Division Multi access (CDMA), Code Division Multi Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), 4th Generation mobile telecommunication (4G), 5th Generation mobile telecommunication (5G), etc.).

The wireless Internet module refers to a module for wireless Internet access, and may be configured to perform communication through Wireless LAN (WLAN), Wireless-Fidelity (Wi-Fi), Wi-Fi direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), Bluetooth tethering, cellular hotspot, or similar technologies, etc. The wireless Internet module may support real-time map updates, streaming of vehicle diagnostics, or cloud-based decision-making support, etc.

The short-range communication module may support short-range communication by using at least one of Bluetooth™, radio frequency identification (RFID), infrared data association (IrDA), ultra wideband (UWB), ZigBee, near field communication (NFC), a wireless universal serial bus (USB) technique, or any combination thereof. Such communication may be used for keyless entry, mobile device pairing, or local V2V coordination, etc.

The storage 120 may be configured to store sensing results of the sensing device 200 and data and/or algorithms used for the processor 140 to operate, including control logic, environment models, or machine learning parameters, etc.

For example, the storage 120 may be configured to store a maximum level, a minimum level, and a minimum time remaining until the yielding candidate vehicle arrives at an end point of a yielding section, a maximum time remaining until the yielding candidate vehicle arrives at the end point of the yielding section, etc., which are determined in advance for level determination. Furthermore, the storage 120 may be configured to store a predetermined maximum gain, a minimum gain, a maximum host vehicle speed, a minimum host vehicle speed, etc, for final level determination. In the instant case, the level may represent a degree for yielding. These parameters may be empirically derived from driving data, safety margins, or regulatory standards, etc.

The storage 120 may include a storage medium of at least one type among memories of types such as a flash memory, a hard disk, a micro, a card (e.g., a secure digital (SD) card or an extreme digital (XD) card, or a microSD card, etc.), a random access memory (RAM), a static RAM (SRAM), a read-only memory (ROM), a programmable ROM (PROM), an electrically erasable PROM (EEPROM), a magnetic memory (MRAM), a magnetic disk, and an optical disk. The choice of storage medium may depend on system constraints such as speed, endurance, cost, or environmental tolerance, etc.

The interface device 130 may include an input means for receiving a control command from a user and an output means for outputting an operation state of the apparatus 100 and results thereof. Herein, the input means may include a key button, and may include a mouse, a joystick, a jog shuttle, a stylus pen, a touchpad, or a rotary controller, etc. Furthermore, the input means may include a soft key implemented on the display. Voice recognition and gesture input systems may also be used as input means in some configurations.

The interface device 130 may be implemented as a head-up display (HUD), a cluster, an audio video navigation (AVN), or a human machine interface (HM), a human machine interface (HMI) (e.g., a digital cockpit, central control panel, or infotainment system, etc.).

The output device may include a display, and may also include a voice output means such as a speaker. In the instant case, in a response to a case that a touch sensor formed of a touch film, a touch sheet, or a touch pad is provided on the display, the display may operate as a touch screen, and may be implemented in a form in which an input device and an output device are integrated. In the present disclosure, the output device may output a driving situation of the autonomous vehicle, a driving path to a destination, a yielding control situation in a merging section, a system alert, or real-time traffic and map updates, etc.

In the instant case, the display may include at least one of a liquid crystal display (LCD), a thin film transistor liquid crystal display (TFT LCD), an organic light emitting diode display (OLED display), a flexible display, a field emission display (FED), and a 3D display. For examples, holographic or curved displays may also be employed for immersive visualization, etc.

The processor 140 may be electrically connected to the communication device 110, the storage 120, the interface unit 130, and other internal or external modules, etc., and configured to perform overall control such that each component may normally perform its function. Furthermore, the processor 140 may be an electrical circuit that may be configured to electrically control each component, and to execute a command of software, thereby performing various data processing and calculations to be described later. Such processing may include object recognition, path planning, risk assessment, or speed profile generation, etc.

The processor 140 may be implemented in the form of hardware, software, or a combination hardware and software. The processor 140 may be implemented with an application specific integrated circuit (ASIC), a digital signal processor (DSP), a programmable logic device (PLD), a field programmable gate array (FPGA), a central processing unit (CPU), a microcontroller, a microprocessor and/or the like, but the present disclosure is not limited thereto. For example, it may be, an electronic control unit (ECU), a micro controller unit (MCU), or other subcontrollers mounted in the vehicle. In other implementations, the processor may be distributed across multiple computing platforms, such as vehicle domain controllers, edge servers, or AI accelerators, etc.

The processor 140 may be configured to select at least one yielding target candidate vehicle that is expected or predicted to enter a merging road on which the host vehicle is driving in a road merging section, select a final yielding target vehicle from among the at least one yielding target candidate vehicle by determining a yielding level of the at least one yielding target candidate vehicle, and perform yielding control for a final yielding target vehicle. This control may involve adjusting acceleration, deceleration, or gap distance to safely accommodate merging behavior, etc.

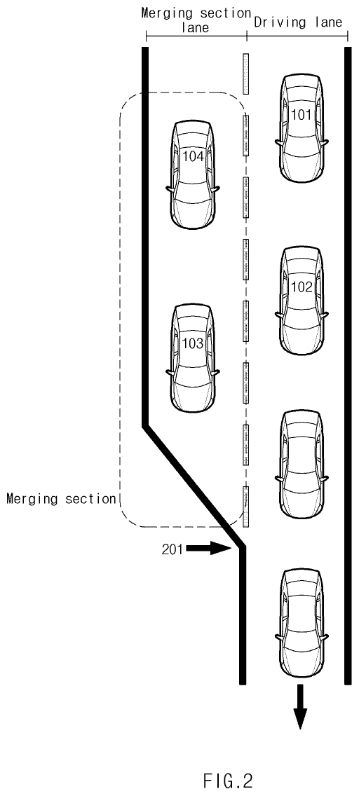

In the instant case, the yielding target candidate vehicle, which is a vehicle driving in the merging section that is a lane next to a lane on which the host vehicle is driving, may indicate a vehicle that is expected or predicted to enter a driving road of the host vehicle at an end point 201 of the merging section, and in FIG. 2, a first object 104 and a second object 105 may be yielding target candidate vehicles. FIG. 2 shows an example of a road merging section. For examples, merging vehicles may include a vehicle accelerating from an on-ramp, a motorcycle weaving through lanes, or a heavy-duty truck entering from a right-hand merge lane, etc.

A road merging section may take various forms depending on the design and traffic flow characteristics of the roadway. For example, a tapered merging section gradually narrows a lane into an adjacent lane over a defined distance, commonly seen on highways and freeways. A loop ramp merging section connects a curved off-ramp or on-ramp to a mainline road, often requiring vehicles to merge at lower speeds. A converging acceleration lane, such as those found at highway entry points, allows entering vehicles to accelerate before merging with main traffic. In urban environments, slip roads or auxiliary lanes are frequently used to transition traffic from service roads or feeder roads into main roadways. Additionally, roundabout exits, where two exit lanes converge into one downstream lane, or construction zones with temporary lane reductions, may also function as merging sections. These varying configurations create different merging dynamics that autonomous driving systems may recognize and adapt to.

Furthermore, the final yielding target vehicle may be selected as a target vehicle, and the processor 140 may be configured to generate a speed profile for tracking the target vehicle for the final yielding target vehicle. The speed profile may consider desired inter-vehicle distance, acceleration constraints, or traffic flow dynamics, etc.

The processor 140 may be configured to select at least one yielding target candidate vehicle by using at least one of a host vehicle speed, surrounding object information, merging section information, or a combination thereof. In the instant case, the surrounding object information may include positions or speeds of objects around the host vehicle, and the merging section information may include at least one of a start point of a road merging section, an end point of the road merging section, a type of the road merging section, a driving direction of the road merging section, or a combination thereof. For instance, merging section types may include taper-type merges, ramp merges, or roundabout entries, etc.

The processor 140 may be configured to select a vehicle as a yielding target candidate vehicle in response to a case where there is the vehicle that is driving in a merging section, which is a lane next to the lane on which the host vehicle is driving, and has a risk of collision with the host vehicle at the end point of the road merging section, which exceeds a predetermined reference. Such a reference may be based on time-to-collision (TTC), projected lateral displacement, or combined speed vector analysis, etc.

The processor 140 may be configured to determine a yielding level by using at least one of a predetermined maximum yielding level, a predetermined minimum yielding level, a minimum time remaining until a predetermined yielding target candidate vehicle arrives at a merging end point, a maximum time remaining until the predetermined yielding target candidate vehicle arrives at the merging end point, and a time remaining until the yielding target candidate vehicle arrives at the merging end point, or a combination thereof. For example, the yielding level may be influenced by whether the merging vehicle is accelerating aggressively, approaching from a curved ramp, or rapidly closing the gap to the host vehicle, etc.

The processor 140 may be configured to determine a final yielding level by using at least one of the determined yielding level, a predetermined maximum gain, a predetermined minimum gain, a predetermined maximum host vehicle speed, a predetermined minimum host vehicle speed, a host vehicle speed, or a combination thereof. For examples, a gain value used for adjusting a yielding level may vary based on roadway conditions (e.g., wet pavement, poor visibility, or high-speed zones, etc.), or vehicle characteristics such as size, type, or maneuverability, etc.

For example, the processor 140 may be configured to determine the yielding level as in Equation 1 below.

$$Yielding level = min ( max ( \frac{A - B}{C - D} ( E - D ) + B , B ) , A ) \qquad ( Equation 1 )$$

A indicates the maximum yielding level, B indicates the minimum yielding level, C indicates the minimum time remaining until the yielding target candidate vehicle arrives at the merging end point, D indicates the maximum time remaining until the yielding target candidate vehicle arrives at the merging end point, and E indicates the time remaining until the yielding target candidate vehicle arrives at the merging end point. In the instant case, the maximum yielding level, the minimum yielding level, the minimum time remaining until the yielding target candidate vehicle arrives at the merging end point, and the maximum time remaining until the yielding target candidate vehicle arrives at the merging end point may be determined in advance by experimental values to be stored in the storage 120. Such experimental values may be derived from real-world traffic data, driving simulations, or safety standards (e.g., minimum time-to-collision thresholds, driver comfort margins, or regulatory guidelines, etc.).

The processor 140 may be configured to divide a value (A-B) obtained by subtracting the minimum yielding level from the maximum yielding level by a value (C-D) obtained by subtracting the maximum time remaining until the yielding target candidate vehicle arrives at the merging end point from the minimum time remaining until the yielding target candidate vehicle arrives at the merging end point. This normalized rate may be used to dynamically scale the yielding level based on how urgently the merging vehicle is approaching.

The processor 140 may be configured to select a maximum value (MAX) from among a minimum yielding level (B) and a value

$$\frac{A - B}{C - D} ( E - D ) + B ,$$

wherein a value

$$\frac{A - B}{C - D} ( E - D )$$

is obtained by multiplying the result

$$\frac{A - B}{C - D}$$

and multiplying a value (E-D) obtained by subtracting the maximum time remaining until the yielding target candidate vehicle arrives at the merging end point from the time remaining until the yielding target candidate vehicle arrives at the merging end point, wherein the value

$$\frac{A - B}{C - D} ( E - D ) + B$$

is obtained by adding the value

$$\frac{A - B}{C - D} ( E - D )$$

and the minimum yielding level (B). Such a formulation may adapt yielding behavior based on different driving contexts (e.g., fast-approaching vehicles, staggered merges, or high-density traffic, etc.).

Next, the processor 140 may be configured to select a minimum value (MIN) from among the selected maximum value (MAX) and the maximum yielding level (A), and determine the selected minimum value (MIN) as the yielding level. This step ensures that the yielding level stays within a safe and predefined operational range, avoiding excessive or insufficient response levels.

The processor 140 may be configured to determine the final yielding level by using the yielding level determined in Equation 1 as shown in Equation 2 below.

$$Final yielding level = {yielding level}^{*} max ( min ( \frac{F - G}{H - I} ( J - I ) , F ) , G ) \qquad ( Equation 2 )$$

F indicates a maximum gain, G indicates a minimum gain, H indicates a maximum host vehicle speed, I indicates a minimum host vehicle speed, and J indicates a host vehicle speed.

In the instant case, the maximum gain (F), the minimum gain (G), the maximum host vehicle speed (H), and the minimum host vehicle speed (I) may be determined in advance by experimental values to be stored in the storage 120. The host vehicle speed (J) may refer to the speed of the host vehicle while it is running. Such gain values may be empirically derived to reflect optimal responsiveness in various driving contexts (e.g., merging at highway speeds, low-speed urban intersections, or congested ramps, etc.).

As described above, the processor 140 may be configured to determine each final yielding level of the at least one yielding target candidate vehicle. This may enable the vehicle system to assign priority dynamically and proportionally across multiple merging candidates based on real-time traffic behavior.

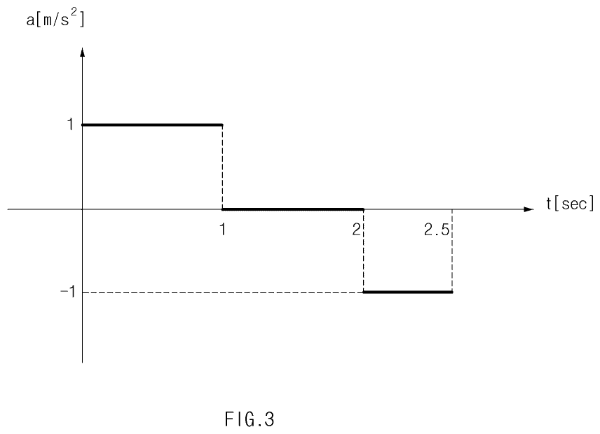

Furthermore, the processor 140 may be configured to generate a speed profile for tracking the target vehicle for each of the at least one yielding candidate vehicle, as shown in FIG. 3, by using a control target distance reflecting the final yielding level determined for each of the at least one yielding target candidate vehicle and a deceleration tuning parameter reflecting the final yielding level determined for each of the at least one yielding target candidate vehicle. For example, a higher final yielding level may result in an increased following distance and smoother deceleration profile, especially when interacting with larger or faster merging vehicles (e.g., trucks, buses, or aggressive passenger cars, etc.). FIG. 3 shows an example speed profile of an autonomous driving control apparatus.

The processor 140 may be configured to select a yielding target candidate vehicle having a speed profile with a smallest acceleration average value for a predetermined time period as the final yielding target candidate vehicle by comparing acceleration average values for the predetermined time period among speed profiles for target vehicle tracking generated for each of the at least one yielding target candidate vehicle. For example, this comparison may be used to identify the safest and most stable vehicle to yield to, particularly in complex merge scenarios (e.g., simultaneous merges, staggered lane drops, or multilane highways, etc.).

The processor 140 may be configured to generate a speed profile for tracking the target vehicle, which selects the final yielding target vehicle as the target vehicle, a speed profile for tracking an event target speed, a speed profile for tracking a maximum operating speed, and a speed profile for minimal risk maneuver (MRM). For example, each profile may be tuned to optimize for different goals, such as comfort, efficiency, compliance with legal speed limits, or collision avoidance, etc.

The processor 140 may be configured to perform yielding control for the final yielding target vehicle tracking the speed profile with the smallest acceleration average value for the predetermined time period by comparing the acceleration average value for the predetermined time period in each of the speed profile for tracking the target vehicle, which selects the final yielding target vehicle as the target vehicle, the speed profile for tracking the event target speed, the speed profile for tracking a maximum operating speed, and the speed profile for minimal risk maneuver (MRM). This may ensure that the vehicle follows the most stable and energy-efficient path while yielding, helping to reduce unnecessary acceleration-deceleration cycles.

The speed profile for tracking the event target speed may include a speed profile for tracking in event situations including entering a curved section road and entering a merging road section.

The speed profile for tracking the maximum operating speed may include a speed profile for tracking a maximum operating speed, including a road speed limit and a design maximum speed of the autonomous driving system. For example, other situations for the speed profile may include sudden braking of a leading vehicle, sharp turns, lane obstructions, or detection of nearby road users (e.g., pedestrians, cyclists, or scooters, etc.).

The sensing device 200 may include one or more sensors that sense an obstacle, e.g., a preceding vehicle, positioned around the host vehicle and measure a distance to the obstacle and/or a relative speed thereof. Furthermore, the sensing device 200 may be configured to recognize lanes, signs, road markings, traffic lights, or construction zones, etc.

The sensing device 200 may include a plurality of sensors to sense an external object of the vehicle, to obtain information related to a position of the external object, a speed of the external object, a moving direction of the external object, and/or a type of the external object (e.g., vehicles, pedestrians, bicycles or motorcycles, etc.). To this end, the sensing device 200 may include an ultrasonic sensor, a radar, a camera, a laser scanner, and/or a corner radar, a lidar, an acceleration sensor, a yaw rate sensor, a torque measurement sensor and/or a wheel speed sensor, a steering angle sensor, a gyroscope, or a magnetometer, etc. In the present disclosure, information related to surrounding objects may be obtained through a lidar, a radar, a camera, an infrared sensor, or a sensor fusion system combining multiple sensor inputs, etc. Furthermore, in the present disclosure, vehicle speed information may be obtained from a wheel speed sensor, an acceleration sensor, a yaw rate sensor, or a GPS-based velocity estimator, etc.

The map database 300 may be configured to provide map information to the autonomous driving control apparatus 100, and in particular, the map information may include road merging section information. In the instant case, the merging section information may include information such as a start point of the merging section, an end point of the merging section, a shape of the merging section, and a direction of the merging section. Additional attributes may include lane count, merge priority rules, road curvature, elevation profiles, or historical traffic flow patterns, etc.

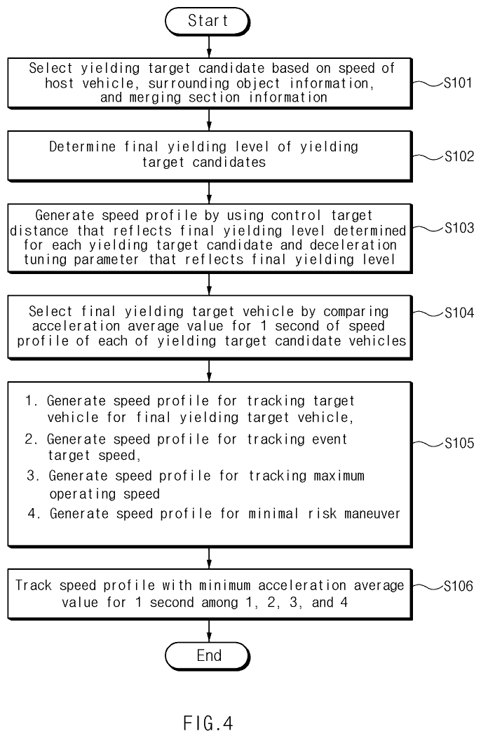

Hereinafter, an autonomous driving control method according to an example of the present disclosure will be described with reference to FIG. 4. FIG. 4 shows an example control method in a road merging section for an autonomous driving control apparatus. The flowchart outlines how the apparatus evaluates and manages merging behaviors to maintain safety and driving comfort.

Hereinafter, it is assumed that the autonomous driving control apparatus 100 of FIG. 1 performs processes of FIG. 4. In addition, in the description of FIG. 4, operations described as being performed by a device may be understood as being controlled by the processor 140 of the autonomous driving control apparatus 100. In following examples, operations S101 to S106 may be performed sequentially, but are not necessarily performed sequentially. For example, an order of each operation may be changed, and at least two operations may be performed in parallel. Such flexibility may allow the vehicle system to adapt to various traffic scenarios (e.g., sudden cut-ins, simultaneous merges, or high-speed conditions, etc.).

Referring to FIG. 4, the autonomous driving control apparatus 100 may be configured to select a yielding target candidate vehicle based on a speed of the host vehicle, surrounding object information, and merging section information (S101). The autonomous driving control apparatus 100 may be configured to obtain vehicle speed information from a wheel speed sensor, an acceleration sensor, a yaw rate sensor, or a GPS receiver, etc. of the sensing device 200.

Furthermore, the autonomous driving control apparatus 100 may be configured to obtain surrounding object information through a lidar, a radar, a camera, an ultrasonic sensor, or a sensor fusion module, etc. of the sensing device 200. In the instant case, surrounding objects may include vehicles (e.g., passenger cars, large trucks, delivery vans, or buses, etc.), pedestrians, two-wheeled vehicles (e.g., motorcycles, bicycles), buildings, traffic cones, or roadside infrastructure, etc. around the vehicle, and the surrounding object information may include positions of the surrounding objects, speeds of the surrounding objects, driving directions of the surrounding vehicles, or object classification types, etc.

The autonomous driving control apparatus 100 may be configured to obtain merging section information from the map database 300. In the instant case, the merging section information may include information such as a start point of the merging section, an end point of the merging section, a shape of the merging section, and a direction of the merging section. For example, additional map attributes may include merge priority rules, lane count transitions, curvature, slope, or historical congestion levels, etc.

As shown in FIG. 2, the yielding target candidate vehicle may be selected from among a preceding vehicle 102 driving in a lane on which the host vehicle 101 is driving and joining vehicles 104 and 105 driving in a merging section lane. The selected vehicle may be prioritized based on merging urgency, proximity, or relative velocity, etc.

For example, from among the merging vehicles driving in the merging section lane, the joining vehicles 104 and 105 ahead of the host vehicle may be selected as the yielding target candidate vehicle. The yielding target candidate vehicles may indicate vehicles expected to need to yield from the host vehicle at the end of the merging section. Other examples may include vehicles entering from an adjacent on-ramp at high speed, vehicles signaling an intent to merge, or vehicles approaching from a blind-spot zone, etc.

Next, the autonomous driving control apparatus 100 may be configured to determine whether a remaining time until the selected yielding target candidate vehicles arrive at a merging end point is greater than a predetermined threshold (t), and in response to a case where the remaining time until the selected yielding target candidate vehicles arrive at the merging end point is greater than the predetermined threshold (t), determine a final yielding level of each of the selected yielding target candidate vehicles (S102). This determination may be based on predicted vehicle trajectories, acceleration patterns, or route intention data received via V2X communication, etc. For example, in response to a case where a time remaining until a yielding target candidate vehicle 1 arrives at the merging end point is greater than the predetermined threshold (t), a final yielding level of the yielding target candidate vehicle 1 may be determined, and in response to a case where the time remaining until the yielding target candidate vehicle 2 arrives at the merging end point is less than or equal to the predetermined threshold (t), a final yielding level of the yielding target candidate vehicle 2 may not be determined. This logic may enable the vehicle system to focus computational and control resources on vehicles that pose a timely merging influence, while deprioritizing vehicles farther away or unlikely to interact. This approach helps prioritize interactions with vehicles that are most relevant to imminent merging conflicts (e.g., rapidly approaching vehicles, vehicles signaling lane changes, or vehicles entering from high-speed ramps, etc.).

The autonomous driving control apparatus 100 may be configured to check whether the remaining time until the yielding target candidate vehicle arrives at the end point of the yielding section is greater than a predetermined reference time, and in response to a case where it is greater than the predetermined reference time, determine the yielding level. Such reference time may be adjusted dynamically based on vehicle class (e.g., sedan, SUV, or heavy truck), road conditions (e.g., wet, icy, or dry), or environmental factors (e.g., fog, glare, or night driving, etc.).

As in Equation 1, the autonomous driving control apparatus 100 may be configured to determine the yielding level using the time remaining until the yielding target candidate vehicle arrives at an end point of the yielding section, and as in Equation 2, determine a final yielding level using the yielding level determined in Equation 1 and a vehicle speed of the host vehicle. This approach may ensure that both urgency (time to merge) and feasibility (host vehicle responsiveness) are considered when establishing yielding priorities.

The autonomous driving control apparatus 100 may be configured to generate a speed profile for tracking the target vehicle by using a control target distance that reflects a final yielding level determined for each yielding target candidate vehicle and a deceleration tuning parameter that reflects a final yielding level determined for each yielding target candidate vehicle (S103). The deceleration tuning parameter may vary depending on driving conditions (e.g., wet roads, downhill gradients, or stop-and-go traffic, etc.) and the type of the merging vehicle (e.g., compact car, motorcycle, or truck, etc.).

For example, assuming that there are the yielding target candidate vehicle 1 and the yielding target candidate vehicle 2, and the yielding level of the yielding target candidate vehicle 1 is 0.5 and a yielding level of the yielding target candidate vehicle 2 is 0.7, and the control target distance for controlling an inter-vehicle distance from the preceding vehicle is 20 m, the control target distance of the yielding target candidate vehicle 1 is 20 m*0.5=10 m, and the control target distance of yielding target candidate vehicle 2 is 20 m*0.7=14 m. This shows how different yielding levels influence the space the host vehicle maintains for smooth interaction.

In the instant case, the control target distance of the yielding target candidate vehicle 1 is shorter than that of the yielding target candidate vehicle 2, so a control amount of the determined acceleration profile may be reduced, enabling smooth control from the driver's perspective. This reduction may reduce or minimize unnecessary braking or acceleration, contributing to passenger comfort and traffic flow stability.

However, in response to a case where the preceding vehicle is included among the yielding target candidate vehicles, the preceding vehicle may have a yielding level set to 1. This may ensure the vehicle system fully respects the role of the immediately preceding vehicle in longitudinal control, regardless of its merging behavior.

The autonomous driving control apparatus 100 may be configured to select a final yielding target vehicle by comparing an acceleration average value for 1 second of the speed profile of each of the yielding target candidate vehicles (S104). This approach favors a vehicle that results in the smoothest and most predictable trajectory when followed (e.g., low acceleration variance, consistent speed trend, or alignment with traffic flow, etc.).

For example, in FIG. 2, in response to a case where the average acceleration value for 1 second of the speed profile of the yielding target candidate vehicle 103 is 0.8 and the average acceleration value for 1 second of the speed profile of the yielding target candidate vehicle 104 is 0.7, the yielding target candidate vehicle 104 may be selected as the final yielding target vehicle. In the instant case, the final yielding target vehicle may refer to a vehicle to which the host vehicle is to ultimately yield. This vehicle may present the most stable and predictable behavior in terms of merging path, lane alignment, or velocity maintenance, etc.

Then, the autonomous driving control apparatus 100 may be configured to generate a speed profile for tracking the target vehicle for the final yielding target vehicle, generate a speed profile for tracking an event target speed, generate a speed profile for tracking a maximum operating speed, and generate a speed profile for minimal risk maneuver (MRM) (S105). In the instant case, the speed profile may indicate a distribution of speed or acceleration over time, and a method for generating the speed profile may use a method for generating a normal speed profile. The generation may leverage polynomial curve fitting, Kalman filtering, or deep learning-based trajectory prediction models, etc.

In the instant case, the speed profile for tracking a target vehicle for the final yielding target candidate vehicle may be generated to select the final yielding target candidate vehicle as the target vehicle and to track the target vehicle. In the instant case, the target vehicle may include not only the final yielding target vehicle, but also a preceding vehicle, a cut-in vehicle, a lead vehicle in a platoon, or an emergency vehicle merging under priority rules, etc.

Furthermore, the speed profile for tracking the event target speed may refer to the speed profile for tracking in event situations (e.g., in a case of entering a curved section road, entering a merging road, responding to sudden braking of a nearby vehicle, or reacting to a construction zone warning, etc.).

Furthermore, the speed profile for tracking the maximum operating speed may be generated to track the maximum operating speed (e.g., a road speed limit, a design maximum speed of an autonomous driving system, or a dynamic speed cap based on weather or V2X alerts, etc.).

Furthermore, the speed profile for minimal risk maneuver (MRM) may include a value for controlling the speed of a vehicle when driving with minimal risk maneuver (MRM). The MRM may activate in fail-safe scenarios such as sensor degradation, software fallback modes, or detection of erratic nearby vehicle behavior, etc.

Accordingly, the autonomous driving control apparatus 100 may be configured to track a speed profile with a minimum acceleration average value for a predetermined time (e.g., 1 second) among the speed profile for tracking the target vehicle for the final yielding target, the speed profile for tacking the event target speed, the speed profile for tracking the maximum operating speed, and the speed profile for minimal risk maneuver (MRM) (S106). This may ensure the host vehicle follows the smoothest trajectory that reduces oscillation, energy loss, or discomfort to occupants.

For example, in response to a case where the average acceleration value for 1 second of the speed profile for tracking the target vehicle for the final yielding target is 0.5, the average acceleration value for 1 second of the speed profile for tracking the event target speed is 0.6, the average acceleration value for 1 second of the speed profile for tracking the maximum operating speed is 0.7, and the average acceleration value for 1 second of the speed profile for minimal risk maneuver (MRM) is 0.8, the average acceleration value for 1 second of the speed profile for tracking the target vehicle for the final yielding target may be the smallest, so the autonomous driving control apparatus 100 may be configured to control the autonomous vehicle to drive by tracking the speed profile for tracking the target vehicle for the final yielding target. This selection process may prioritize not just safety but also efficiency and driving smoothness.

In this way, according to the present disclosure, it may be possible to improve the reliability of autonomous driving control by allowing an autonomous vehicle to select a yielding target from among vehicles attempting to enter a road merging section and control the host vehicle in response to the selected yielding target candidate vehicle. Such approach contributes to enhanced decision-making in complex traffic conditions (e.g., freeway on-ramps, construction bottlenecks, or multi-vehicle merging interactions, etc.).

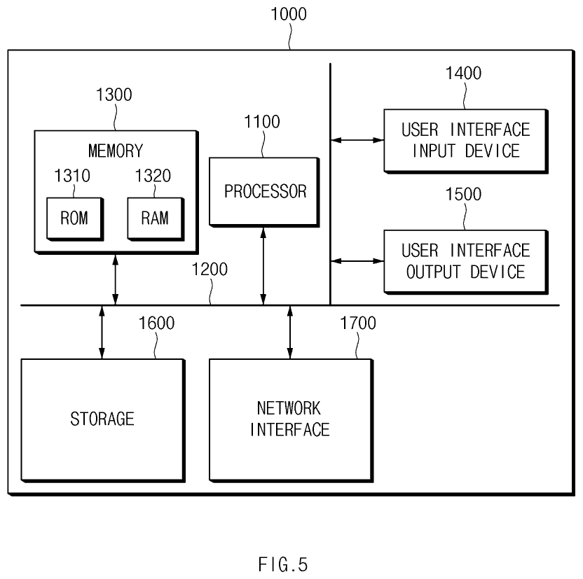

FIG. 5 shows an example computing system.

Referring to FIG. 5, the computing system 1000 includes at least one processor 1100 connected through a bus 1200, a memory 1300, a user interface input device 1400, a user interface output device 1500, and a storage 1600, and a network interface 1700. This configuration may correspond to a central vehicle control circuit, edge processing circuit, or a cloud-interfacing onboard circuitry, etc.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320. Other types of memory may include dynamic RAM (DRAM), synchronous DRAM (SDRAM), or non-volatile dual in-line memory circuits (NVDIMCs), etc.

Accordingly, steps of a method or algorithm described in connection with the examples included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM. Additional storage examples may include solid-state drives (SSDs), embedded MultiMediaCards (eMMC), or Universal Flash Storage (UFS), etc.

An exemplary storage medium is coupled to the processor 1100, which can read information from and write information to the storage medium. Alternatively, the storage medium may be integrated with the processor 1100. The processor and the storage medium may reside within an application specific IC (ASIC). The ASIC may reside within a user terminal. Alternatively, the processor and the storage medium may reside as separate components within the user terminal. In automotive systems, the processor 1100 and the storage medium may be realized as part of an advanced driver-assistance system (ADAS) domain control circuitry, a telematics control circuit (TCC), or an autonomous driving compute platform, etc.

An example of the present disclosure attempts to provide an autonomous driving control apparatus and an autonomous driving control method in a road merging section, capable of controlling an autonomous vehicle to drive at a similar level to that of an actual driver with respect to another object entering a merging road on which the autonomous vehicle is driving in the road merging section.

An example of the present disclosure attempts to provide an autonomous driving control apparatus and an autonomous driving control method in a road merging section, capable of selecting at least one yielding candidate vehicle among surrounding objects during autonomous driving, determining a yielding level of the at least one yielding candidate vehicle, selecting a final yielding vehicle, and performing yielding control for the final yielding vehicle.

The technical objects of the present disclosure are not limited to the objects mentioned above, and other technical objects not mentioned may be clearly understood by those skilled in the art from the description of the claims.

An example of the present disclosure provides an autonomous driving control apparatus including a processor configured to select at least one target candidate vehicle that is expected or predicted to enter a merging road on which a host vehicle is driving in a road merging section, determine a target level of the at least one target candidate vehicle, select a final target vehicle among the at least one target candidate vehicle, and perform control it for the final target vehicle; and a storage configured to store data and algorithms driven by the processor.

In an example of the present disclosure, the processor may be configured to select the at least one target candidate vehicle by using at least one of a host vehicle speed, surrounding object information, merging section information, or a combination thereof.

In an example of the present disclosure, the surrounding object information includes a position or a speed of an object surrounding the host vehicle.

In an example of the present disclosure, the merging section information may include at least one of a start point of the road merging section, an end point of the road merging section, a type of the road merging section, a driving direction of the road merging section, or a combination thereof.

In an example of the present disclosure, the processor may be configured to selects a vehicle as a target candidate vehicle in response to a case where there is the vehicle that is driving in a merging section, which is a lane next to a lane on which the host vehicle is driving, and has a risk of collision with the host vehicle at an end point of the road merging section, which exceeds a predetermined reference.

In an example of the present disclosure, the processor may be configured to determine the level by using at least one of a predetermined maximum level, a predetermined minimum level, a minimum time remaining until a predetermined target candidate vehicle arrives at a merging end point, a maximum time remaining until the predetermined target candidate vehicle arrives at the merging end point, and a time remaining until the target candidate vehicle arrives at the merging end point, or a combination thereof.

In an example of the present disclosure, the processor may be configured to determine a final level by using at least one of the level, a predetermined maximum gain, a predetermined minimum gain, a predetermined maximum host vehicle speed, a predetermined minimum host vehicle speed, a host vehicle speed, or a combination thereof.

In an example of the present disclosure, the processor may be configured, to determine a final level of each of the at least one target candidate vehicle, and to generate a speed profile for tracking a target vehicle for each of the at least one candidate vehicle by using a control target distance reflecting the final level determined for each of the at least one target candidate vehicle and a deceleration tuning parameter reflecting the final level determined for each of the at least one target candidate vehicle.

In an example of the present disclosure, the processor may be configured to select a target candidate vehicle having a speed profile with a smallest acceleration average value for a predetermined time period as the final target candidate vehicle by comparing acceleration average values for the predetermined time period among the speed profile for tracking the target vehicle generated for each of the at least one target candidate vehicle.

In an example of the present disclosure, the processor may be configured to generate the speed profile for tracking the target vehicle, which selects the final target vehicle as the target vehicle, a speed profile for tracking an event target speed, a speed profile for tracking a maximum operating speed, and a speed profile for minimal risk maneuver (MRM).

In an example of the present disclosure, the processor may be configured to perform yielding control for the final target vehicle tracking the speed profile with the smallest acceleration average value for the predetermined time period by comparing the acceleration average value for the predetermined time period in each of the speed profile for tracking the target vehicle, which selects the final target vehicle as the target vehicle, the speed profile for tracking the event target speed, the speed profile for tracking the maximum operating speed, and the speed profile for minimal risk maneuver (MRM).

In an example of the present disclosure, the speed profile for tracking the event target speed may include a speed profile for tracking in event situations including entering a curved section road and entering a merging road section, and the speed profile for tracking the maximum operating speed may include a speed profile for tracking a maximum operating speed, including a road speed limit and a design maximum speed of an autonomous driving system.

An example of the present disclosure provides an autonomous driving control method in a road merging section for an autonomous driving control apparatus, the method including selecting, by the apparatus, at least one target candidate vehicle that is expected to enter a merging road on which a host vehicle is driving in the road merging section, determining, by the apparatus, a target level of the at least one target candidate vehicle, selecting, by the apparatus, a final target vehicle among the at least one target candidate vehicle by using the target level of the at least one target candidate vehicle, and performing, by the apparatus, control on the final target vehicle.

In an example of the present disclosure, the selecting of the at least one target candidate vehicle may include selecting, by the apparatus, the at least one target candidate vehicle by using at least one of a host vehicle speed, surrounding object information, merging section information, or a combination thereof.

In an example of the present disclosure, the surrounding object information may include a position or a speed of an object surrounding the host vehicle, and the merging section information may include at least one of a start point of the road merging section, an end point of the road merging section, a type of the road merging section, a driving direction of the road merging section, or a combination thereof.

In an example of the present disclosure, the selecting of the at least one target candidate vehicle may include selecting, by the apparatus, a vehicle as a target candidate vehicle in response to a case where there is the vehicle that is driving in a merging section, which is a lane next to a lane on which the host vehicle is driving, and has a risk of collision with the host vehicle at an end point of the road merging section, which exceeds a predetermined reference.

In an example of the present disclosure, the determining of the target level of the at least one target candidate may include determining, by the apparatus, the level by using at least one of a predetermined maximum level, a predetermined minimum level, a minimum time remaining until a predetermined target candidate vehicle arrives at a merging end point, a maximum time remaining until the predetermined target candidate vehicle arrives at the merging end point, and a time remaining until the target candidate vehicle arrives at the merging end point, or a combination thereof.

In an example of the present disclosure, the determining of the target level of the at least one target candidate may include determining, by the apparatus, a final level by using at least one of the level, a predetermined maximum gain, a predetermined minimum gain, a predetermined maximum host vehicle speed, a predetermined minimum host vehicle speed, a host vehicle speed, or a combination thereof.

In an example of the present disclosure, the selecting of the final target vehicle
may include selecting, by the apparatus, a target candidate vehicle having a speed profile with a smallest acceleration average value for a predetermined time period as the final target candidate vehicle by comparing acceleration average values for the predetermined time period among the speed profile for tracking the target vehicle generated for each of the at least one target candidate vehicle.

In an example of the present disclosure, the performing of the control on the final target vehicle may include generating, by the apparatus, a speed profile for tracking a target vehicle, which selects the final target vehicle as the target vehicle, a speed profile for tracking an event target speed, a speed profile for tracking a maximum operating speed, and a speed profile for minimal risk maneuver (MRM), comparing, by the apparatus, the acceleration average value for a predetermined time in each of the speed profile for tracking the target vehicle, which selects the final target vehicle as the target vehicle, the speed profile for tracking the event target speed, the speed profile for tracking the operating maximum speed, and the speed profile for minimal risk maneuver (MRM); and controlling, the final target vehicle by tracking a speed profile with a smallest acceleration average value for the predetermined time period.

According to the present technique, it may be possible to increase user satisfaction and reliability of autonomous vehicles by controlling an autonomous vehicle to drive at a similar level to that of an actual driver with respect to another object entering a road merging into a road on which the autonomous vehicle is driving in the road merging section.

Furthermore, according to the present technique, it may be possible to efficiently perform yielding control in a road merging section by selecting at least one yielding candidate vehicle among surrounding objects during autonomous driving, determining a yielding level of the at least one yielding candidate vehicle, selecting a final yielding vehicle, and performing the yielding control for the final yielding vehicle.

The above description is merely illustrative of the technical idea of the present disclosure, and those skilled in the art to which the present disclosure pertains may make various modifications and variations without departing from the essential characteristics of the present disclosure.

Therefore, the examples disclosed in the present disclosure are not intended to limit the technical ideas of the present disclosure, but to explain them, and the scope of the technical ideas of the present disclosure is not limited by these examples. The protection range of the present disclosure should be interpreted by the claims below, and all technical ideas within the equivalent range should be interpreted as being included in the scope of the present disclosure.

What is claimed:

1. An apparatus for controlling autonomous driving of a host vehicle, the apparatus comprising:
a processor; and
a memory storing at least one instruction that, when executed by the processor communicating with the memory, is configured to cause the apparatus to:
select at least one target candidate vehicle that is expected to enter a road merging section on which the host vehicle is driving,
determine a target yielding level associated with the at least one target candidate vehicle, wherein the target yielding level corresponds to a value indicating a likelihood for the host vehicle to yield to the at least one target candidate vehicle,
select, based on the determined target yielding level, a final target vehicle among the at least one target candidate vehicle,
output, based on the selected final target vehicle, a signal, and
control, based on the signal, autonomous driving of the host vehicle to yield to the final target vehicle.

2. The apparatus of claim 1, wherein the at least one instruction, when executed by the processor communicating with the memory, is configured to cause the apparatus to select, based on at least one of a speed of the host vehicle, information about an object within a threshold distance of the host vehicle, or merging section information about the road merging section, the final target vehicle among the at least one target candidate vehicle.

3. The apparatus of claim 2, wherein the information about the object comprises a position or a speed of the object.

4. The apparatus of claim 2, wherein the merging section information comprises at least one of:
a start point of the road merging section,
an end point of the road merging section,
a type of the road merging section, or
a driving direction of the road merging section.

5. The apparatus of claim 1, wherein the at least one instruction, when executed by the processor communicating with the memory, is configured to cause the apparatus to select a vehicle as a target candidate vehicle based on:
the vehicle driving in a lane next to a lane on which the host vehicle is driving, and
the vehicle having a risk of collision with the host vehicle at an end point of the road merging section, wherein the risk of collision exceeds a predetermined reference value.

6. The apparatus of claim 1, wherein the at least one instruction, when executed by the processor communicating with the memory, is configured to cause the apparatus to determine the target yielding level associated with the at least one target candidate vehicle based on at least one of:
a predetermined maximum yielding level,
a predetermined minimum yielding level,
a minimum time threshold for arrival of the at least one target candidate vehicle at a merging end point,
a maximum time threshold for arrival of the at least one target candidate vehicle at the merging end point, or
a current time remaining until the at least one target candidate vehicle arrives at the merging end point.

7. The apparatus of claim 1, wherein the at least one instruction, when executed by the processor communicating with the memory, is configured to cause the apparatus to determine a final yielding level based on at least one of:
the target yielding level,
a predetermined maximum adjustment factor applied to the target yielding level,
a predetermined minimum adjustment factor applied to the target yielding level,
a predetermined maximum speed of the host vehicle,
a predetermined minimum speed of the host vehicle, or
a current speed of the host vehicle.

8. The apparatus of claim 7, wherein the at least one instruction, when executed by the processor communicating with the memory, is configured to cause the apparatus to:
determine a final yielding level of each of the at least one target candidate vehicle, and
generate a speed profile for tracking a target vehicle for each of the at least one target candidate vehicle, based on:
a control target distance, wherein the control target distance defines an inter-vehicle distance to be maintained between the host vehicle and the target vehicle, and wherein the control target distance is determined based on the final yielding level, and
a deceleration tuning parameter, wherein the deceleration tuning parameter is used to adjust a deceleration rate of the host vehicle during the tracking, and wherein the deceleration tuning parameter is determined based on the final yielding level.

9. The apparatus of claim 8, wherein the at least one instruction, when executed by the processor communicating with the memory, is configured to cause the apparatus to select a target candidate vehicle having a speed profile with a smallest acceleration average value for a predetermined time period as a final target candidate vehicle by comparing acceleration average values for the predetermined time period among the speed profiles generated for each of the at least one target candidate vehicle for tracking the target candidate vehicle.

10. The apparatus of claim 9, wherein the speed profile with the smallest acceleration average value is selected among:
a speed profile for tracking an event target speed,
a speed profile for tracking a maximum operating speed, and
a speed profile for minimal risk maneuver (MRM).

11. The apparatus of claim 10, wherein
the speed profile for tracking the event target speed comprises a speed profile generated for tracking in event situations, wherein the event situations comprises entering a curved road section and entering the road merging section, and
the speed profile for tracking the maximum operating speed comprises a speed profile based on a maximum operating speed, wherein the maximum operating speed comprises at least one of a road speed limit or a design maximum speed of an autonomous driving system.

12. A method performed by an apparatus for controlling autonomous driving of a host vehicle, the method comprising:
selecting at least one target candidate vehicle that is expected to enter a road merging section on which the host vehicle is driving;
determining a target yielding level associated with the at least one target candidate vehicle, wherein the target yielding level corresponds to a value indicating a likelihood for the host vehicle to yield to the at least one target candidate vehicle;
selecting, based on the determined target yielding level, a final target vehicle among the at least one target candidate vehicle;
outputting, based on the selected final target vehicle, a signal; and
controlling, based on the signal, autonomous driving of the host vehicle to yield to the final target vehicle.

13. The method of claim 12, wherein the selecting of the final target vehicle comprises selecting, based on at least one of a speed of the host vehicle, information about an object within a threshold distance of the host vehicle, or merging section information about the road merging section, the final target vehicle among the at least one target candidate vehicle.

14. The method of claim 13, wherein:
the information about the object comprises a position or a speed of the object, and
the merging section information comprises at least one of:
a start point of the road merging section,
an end point of the road merging section,
a type of the road merging section, or
a driving direction of the road merging section.

15. The method of claim 12, wherein the selecting of the final target vehicle comprises selecting a vehicle as a target candidate vehicle based on:
the vehicle driving in a lane next to a lane on which the host vehicle is driving, and
the vehicle having a risk of collision with the host vehicle at an end point of the road merging section, wherein the risk of collision exceeds a predetermined reference value.

16. The method of claim 13, wherein the determining of the target yielding level associated with the at least one target candidate vehicle comprises determining the target yielding level based on at least one of:
a predetermined maximum yielding level,
a predetermined minimum yielding level,
a minimum time threshold for arrival of the at least one target candidate vehicle at a merging end point,
a maximum time threshold for arrival of the at least one target candidate vehicle at the merging end point, or
a current time remaining until the at least one target candidate vehicle arrives at the merging end point.

17. The method of claim 16, wherein the determining of the target yielding level associated with the at least one target candidate vehicle further comprises determining a final yielding level based on at least one of:
the target yielding level,
a predetermined maximum adjustment factor applied to the target yielding level,
a predetermined minimum adjustment factor applied to the target yielding level,
a predetermined maximum speed of the host vehicle,
a predetermined minimum speed of the host vehicle, or
a current speed of the host vehicle.

18. The method of claim 17, wherein the selecting of the final target vehicle comprises selecting a target candidate vehicle having a speed profile with a smallest acceleration average value for a predetermined time period as a final target candidate vehicle by comparing acceleration average values for the predetermined time period among the speed profiles generated for each of the at least one target candidate vehicle for tracking the target candidate vehicle.

19. An apparatus for controlling autonomous driving of a vehicle, the apparatus comprising:
a processor; and
a memory storing at least one instruction that, when executed by the processor communicating with the memory, is configured to cause the apparatus to:
select at least one target candidate vehicle predicted to enter a merging road on which the vehicle is driving, based on at least one of object information associated with the vehicle or merging section information associated with the merging road;
determine a yielding level associated with each of the at least one target candidate vehicle based on at least one of a collision risk or a time remaining until the at least one target candidate vehicle arrives at an end point of the merging road, wherein the yielding level corresponds to a value indicating a likelihood for the vehicle to yield to the at least one target candidate vehicle;
select, based on the determined yielding level, a target vehicle from the at least one target candidate vehicle;
output a signal indicating the selected target vehicle; and
control, based on the signal, autonomous driving of the vehicle to yield to the selected target vehicle.

20. The apparatus of claim 19, wherein:
the object information comprises at least one of a position or a speed of an object within a threshold range of the vehicle;
the merging section information comprises at least one of a start point, an end point, a type, or a driving direction of the merging road;
the selected target vehicle has a speed profile with a smallest acceleration average value for a predetermined time period; and
the determining the yielding level is further based on at least one of a predetermined maximum yielding level or a predetermined minimum yielding level.
